(19) United States
(12) Patent Application Publication
(10) Pub. No.: US 2025/0245843 A1
(43) Pub. Date: Jul. 31, 2025

(54) IMAGE PROCESSOR AND IMAGE PROCESSING SYSTEM INCLUDING THE SAME

(71) Applicant: SK hynix Inc.

(72) Inventor: Ji Hee HAN, Gyeonggi-do (KR)

(21) Appl. No.: 18/762,676

(22) Filed: Jul. 3, 2024

(30) Foreign Application Priority Data
Jan. 31, 2024 (KR) 10-2024-0014982

(51) Int. Cl. G06T 7/50; G06T 5/50; G06T 15/06; G06V 10/762

(52) U.S. Cl. CPC G06T 7/50; G06T 5/50; G06T 15/06; G06V 10/762; G06T 2207/20224

(57) ABSTRACT

Disclosed is an image processor and an image processing system including the same, and the image processor may include a first pre-processor configured to generate a first point cloud based on a sparse depth map, a first post-processor configured to model a surface of the sparse depth map based on the first point cloud, a second pre-processor configured to generate a difference frame corresponding to a difference between a previous frame and a current frame, a second post-processor configured to generate a second point cloud of a dimension corresponding to the sparse depth map, based on the difference frame, and a generator configured to generate a dense depth map using the second point cloud and the modeled surface.

### CROSS-REFERENCE TO RELATED APPLICATION(S)

This application claims priority under 35 U.S.C. § 119 to Korean Patent Application No. 10-2024-0014982, filed on Jan. 31, 2024, the disclosure of which is incorporated herein by reference in its entirety.

### BACKGROUND

### 1. Field

Various embodiments of the present disclosure relate to a semiconductor design technique, and more particularly, to an image processor that generates a depth map, and an image processing system including the image processor.

### 2. Description of the Related Art

Light detection and ranging (LIDAR) or an image sensor may be used to obtain a depth map.

LiDAR has a structure in which depth is acquired using a laser. LIDAR acquires a sparse depth map with low density in the form of a point cloud. The sparse depth map has high accuracy, but its possible application fields are limited due to its low density.

The image sensor has the advantage of being cheaper than LIDAR and has a wider range of use (i.e., the image sensor can be used in various weather and situations) but has the disadvantage of low accuracy of an acquired depth map.

For reference, image sensors are devices for capturing images using the property of a semiconductor which reacts to light. The image sensors may be classified into charge-coupled device (CCD) image sensors and complementary metal-oxide semiconductor (CMOS) image sensors. Recently, CMOS image sensors are widely used because the CMOS image sensors can allow both analog and digital control circuits to be directly implemented on a single integrated circuit (IC).

### SUMMARY

Various embodiments of the present disclosure are directed to an image processor capable of generating a dense depth map with high accuracy and high density, and an image processing system including the image processor.

In accordance with an embodiment of the present disclosure, an image processor may include: a first pre-processor configured to generate a first point cloud based on a sparse depth map; a first post-processor configured to model a surface of the sparse depth map based on the first point cloud; a second pre-processor configured to generate a difference frame corresponding to a difference between a previous frame and a current frame; a second post-processor configured to generate a second point cloud of a dimension corresponding to the sparse depth map, based on the difference frame; and a generator configured to generate a dense depth map using the second point cloud and the modeled surface.

In accordance with an embodiment of the present disclosure, an image processing system may include: an image generator configured to generate a previous frame and a current frame; a depth information generator configured to generate a sparse depth map; and an image processor configured to generate a difference frame corresponding to a difference between the previous frame and the current frame, and generate a dense depth map based on the difference frame and the sparse depth map.

In accordance with an embodiment of the present disclosure, a method of operating an image processor may include: generating a first point cloud based on a sparse depth map; modeling a surface of the sparse depth map based on the first point cloud; generating a difference frame corresponding to a difference between a previous frame and a current frame; generating a second point cloud of a dimension corresponding to the sparse depth map, based on the difference frame; and generating a dense depth map using the second point cloud and the modeled surface.

### BRIEF DESCRIPTION OF THE DRAWINGS

FIG. 1 is a block diagram illustrating a configuration of an image processing system in accordance with an embodiment of the present disclosure.

FIG. 2 is a block diagram illustrating a detailed configuration of an image processor illustrated in FIG. 1.

FIG. 3 is a block diagram illustrating a detailed configuration of a modeler illustrated in FIG. 2.

FIG. 4 is a block diagram illustrating a detailed configuration of a first post-processor illustrated in FIG. 3.

FIG. 5 is a block diagram illustrating a detailed configuration of a converter illustrated in FIG. 2.

FIG. 6 is a block diagram illustrating a detailed configuration of a generator illustrated in FIG. 2.

FIG. 7 is a diagram for describing an operation of the image processing system illustrated in FIG. 1 in accordance with an embodiment of the present disclosure.

### DETAILED DESCRIPTION

Various embodiments of the present disclosure are described below with reference to the accompanying drawings, in order to describe in detail the present disclosure so that those with ordinary skill in art to which the present disclosure pertains may easily carry out the technical spirit of the present disclosure.

It will be understood that when an element is referred to as being “connected to” or “coupled to” another element, the element may be directly connected to or coupled to the another element, or electrically connected to or coupled to the another element with one or more elements interposed therebetween. In addition, it will also be understood that the terms “comprises,” “comprising,” “includes,” and “including” when used in this specification do not preclude the presence of one or more other elements but may further include or have the one or more other elements, unless otherwise mentioned. In the description throughout the specification, some components are described in singular forms, but the present disclosure is not limited thereto, and it will be understood that the components may be formed in plural.

FIG. 1 is a block diagram illustrating a configuration of an image processing system 10 in accordance with an embodiment of the present disclosure.

Referring to FIG. 1, the image processing system 10 may include a depth information generator 100, an image generator 200, and an image processor 300.

The depth information generator 100 may generate a sparse depth map SDM. The sparse depth map SDM may have a point cloud form and low density. The sparse depth map SDM may have a 3-dimensional form. For example, the depth information generator 100 may include LiDAR.

The image generator 200 may generate a previous frame IMG1 and a current frame IMG2 captured consecutively along a time-axis. That is, the previous frame IMG1 and the current frame IMG2 may be a first frame and a second frame, respectively, which are generated consecutively at a predetermined time interval. The previous frame IMG1 and the current frame IMG2 may each have a 2-dimensional form. For example, the image generator 200 may include an image sensor.

The image processor 300 may generate a dense depth map DDM based on the sparse depth map SDM, the previous frame IMG1 and the current frame IMG2. The dense depth map DDM, which is an improved depth map compared to the sparse depth map SDM, may have high density. The dense depth map DDM may have a 3-dimensional form.

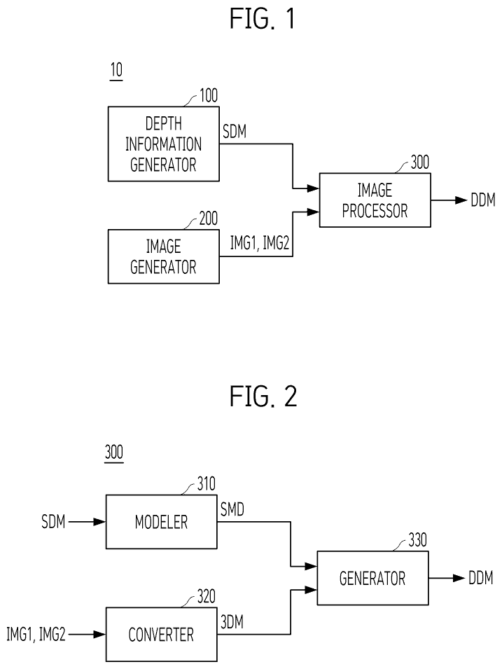

FIG. 2 is a block diagram illustrating a detailed configuration of the image processor 300 illustrated in FIG. 1 in accordance with an embodiment of the present disclosure.

Referring to FIG. 2, the image processor 300 may include a modeler 310, a converter 320, and a generator 330.

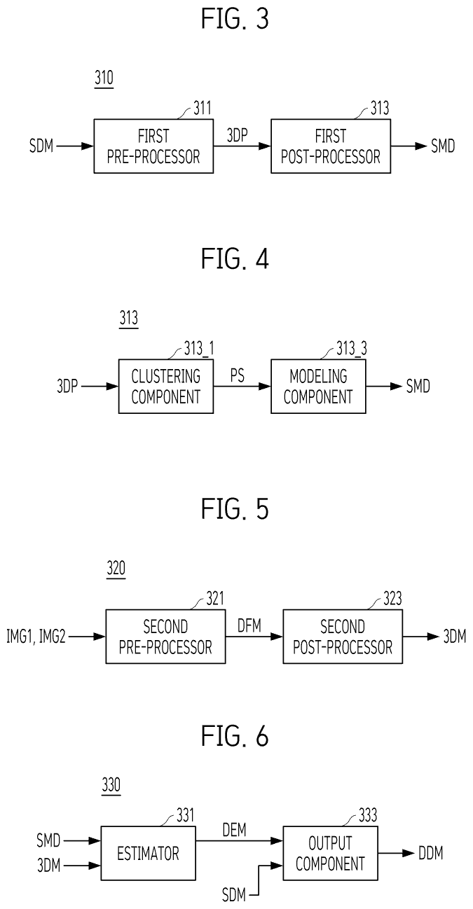

The modeler 310 may model a surface of the sparse depth map SDM and generate a modeled surface SMD, based on the sparse depth map SDM. For example, the modeler 310 may obtain the modeled surface SMD from a point cloud corresponding to the sparse depth map SDM. The point cloud may be a first point cloud 3DP, which is to be described below (refer to FIG. 3).

The converter 320 may generate a point cloud (hereinafter referred to as a “second point cloud”) 3DM in a dimensional form, i.e., the 3-dimensional form, corresponding to the sparse depth map SDM, based on the previous frame IMG1 and the current frame IMG2.

The generator 330 may generate the dense depth map DDM using the second point cloud 3DM and the modeled surface SMD.

FIG. 3 is a block diagram illustrating a detailed configuration of the modeler 310 illustrated in FIG. 2 in accordance with an embodiment of the present disclosure.

Referring to FIG. 3, the modeler 310 may include a first pre-processor 311 and a first post-processor 313.

The first pre-processor 311 may generate a point cloud (hereinafter referred to as the “first point cloud”) 3DP in the 3-dimensional form, based on the sparse depth map SDM. The first pre-processor 311 may obtain the first point cloud 3DP from a specific area that overlaps a field of view corresponding to the current frame IMG2 in the sparse depth map SDM.

The first post-processor 313 may generate the modeled surface SMD based on the first point cloud 3DP. The first post-processor 313 is described in more detail with reference to FIG. 4.

FIG. 4 is a block diagram illustrating a detailed configuration of the first post-processor 313 illustrated in FIG. 3 in accordance with an embodiment of the present disclosure.

Referring to FIG. 4, the first post-processor 313 may include a clustering component 313_1 and a modeling component 313_3.

The clustering component 313_1 may receive the first point cloud 3DP, and cluster the first point cloud 3DP for each subject. Generally, points corresponding to the same subject may be rarely present in a vertical direction, and may be present in large numbers in a horizontal direction. The clustering component 313_1 may use Weighted Euclidean Distance. The clustering component 313_1 may generate a plurality of point sets PS clustered for each subject. That is, each of the plurality of point sets PS may be regarded as sampling data of different subjects.

The modeling component 313_3 may receive the plurality of point sets PS, and generate the modeled surface SMD corresponding to an approximation of a surface of each subject, based on each of the plurality of point sets PS. For example, the modeling component 313_3 may generate the modeled surface SMD using a convex hull algorithm or a Delaunay triangulation algorithm. The convex hull algorithm may generate the modeled surface SMD by estimating virtual points corresponding to points included in each of the plurality of point sets PS. Each of the points included in each of the plurality of point sets PS may include an x-axis value and a y-axis value, and each of the virtual points may include a z-axis value.

FIG. 5 is a block diagram illustrating a detailed configuration of the converter 320 illustrated in FIG. 2 in accordance with an embodiment of the present disclosure.

Referring to FIG. 5, the converter 320 may include a second pre-processor 321 and a second post-processor 323.

The second pre-processor 321 may receive the previous frame IMG1 and the current frame IMG2, and generate a difference frame DFM based on the previous frame IMG1 and the current frame IMG2. The difference frame DFM may correspond to a difference between the previous frame IMG1 and the current frame IMG2. Since the quality of the difference frame DFM improves as the difference between the previous frame IMG1 and the current frame IMG2 increases (i.e., as a movement of a scene increases), using the difference frame DFM has the advantage of being resistant to motion blur and being suitable for a high dynamic range. The second pre-processor 321 may perform a denoising process and an inflation process on the difference frame DFM depending on design.

The second post-processor 323 may generate the second point cloud 3DM based on the difference frame DFM. For example, the second post-processor 323 may back-project the difference frame DFM into a 3-dimensional space, and generate the second point cloud 3DM in the 3-dimensional form corresponding to the back-projected difference frame. In this case, the second post-processor 323 may use ray casting and a pinhole camera model. In particular, the second post-processor 323 may express the difference frame DFM as a vector through the ray casting.

FIG. 6 is a block diagram illustrating a detailed configuration of the generator 330 illustrated in FIG. 2 in accordance with an embodiment of the present disclosure.

Referring to FIG. 6, the generator 330 may include an estimator 331 and an output component 333.

The estimator 331 may receive the modeled surface SMD and the second point cloud 3DM, and estimate dense depth information DEM using the modeled surface SMD and the second point cloud 3DM. The estimator 331 may estimate depth values of intersections between the second point cloud 3DM and the modeled surface SMD, and generate the depth values as the dense depth information DEM. For example, the estimator 331 may calculate the depth values using barycentric coordinates.

The output component 333 may generate the dense depth map DDM based on the dense depth information DEM and the sparse depth map SDM. For example, the output component 333 may generate the dense depth map DDM by filling the depth values into an area, i.e., an empty area, between points included in the sparse depth map SDM, through a depth correction operation. The depth correction operation may include at least one of depth expansion and depth hole filling. The depth expansion may be a processing method of filling the empty area with surrounding depth value(s) while dilating each selected kernel with valid pixels corresponding to the same subject. The depth hole filling may be a method of filling the empty area with surrounding depth value(s) while smoothing the depth values using distance and intensity.

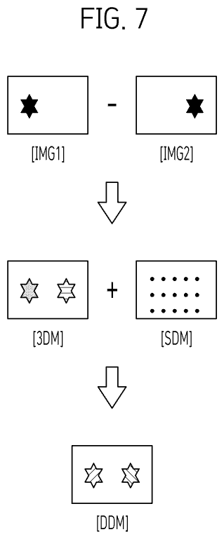

Hereinafter, an operation of the image processing system 10 in accordance with an embodiment of the present disclosure, which has the above-described configuration, is described with reference to FIG. 7.

FIG. 7 is a diagram for describing an operation of the image processing system 10 illustrated in FIG. 1 in accordance with an embodiment of the present disclosure.

Referring to FIG. 7, the image generator 200 may generate the previous frame IMG1 and the current frame IMG2. The previous frame IMG1 and the current frame IMG2 may be generated consecutively.

The image generator 200 may generate the previous frame IMG1 and the current frame IMG2 captured consecutively along the time-axis. That is, the previous frame IMG1 and the current frame IMG2 may be the first frame and the second frame, respectively, generated consecutively at the predetermined time interval. The previous frame IMG1 and the current frame IMG2 may each have a 2-dimensional form.

The depth information generator 100 may generate the sparse depth map SDM. The sparse depth map SDM may have a point cloud form and a 3-dimensional form. The sparse depth map SDM may have high accuracy or low density. The sparse depth map SDM may be generated at a point in time when the current frame IMG2 is generated.

The image processor 300 may generate the difference frame DFM corresponding to a difference between the previous frame IMG1 and the current frame IMG2, based on the previous frame IMG1 and the current frame IMG2. Since the quality of the difference frame DFM improves as the difference between the previous frame IMG1 and the current frame IMG2 increases (i.e., as a movement of a scene increases), using of the difference frame DFM has the advantage of being resistant to motion blur and being suitable for a high dynamic range.

Since the image processor 300 cannot directly combine the difference frame DFM and the sparse depth map SDM, the image processor 300 may combine the difference frame DFM and the sparse depth map SDM by converting the difference frame DFM and the sparse depth map SDM into a point cloud in the same form (e.g., a point cloud form). The image processor 300 may generate the first point cloud 3DP in a 3-dimensional form based on the sparse depth map SDM, and generate the modeled surface SMD corresponding to the first point cloud 3DP. The image processor 300 may generate the second point cloud 3DM in a dimensional form, that is, the 3-dimensional form, corresponding to the sparse depth map SDM, based on the difference frame DFM. The image processor 300 may generate the dense depth map DDM by combining the modeled surface SMD and the second point cloud 3DM. The dense depth map DDM, which is an improved depth map compared to the sparse depth map SDM, may have high accuracy and high density.

According to an embodiment of the present disclosure, a dense depth map with high accuracy and high density may be generated, and thus may be used in an application field such as a vehicle or a satellite system.

According to an embodiment of the present disclosure, a dense depth map with high accuracy and high density may be generated using LIDAR and an image sensor.

While the present disclosure has been illustrated and described with respect to specific embodiments, the disclosed embodiments are provided for the description, and not intended to be restrictive. Further, it is noted that the embodiments of the present disclosure may be achieved in various ways through substitution, change, and modification that fall within the scope of the following claims, as those skilled in the art will recognize in light of the present disclosure. Furthermore, the embodiments may be combined to form additional embodiments.

What is claimed is:

1. An image processor comprising:
a first pre-processor configured to generate a first point cloud based on a sparse depth map;
a first post-processor configured to model a surface of the sparse depth map based on the first point cloud;
a second pre-processor configured to generate a difference frame corresponding to a difference between a previous frame and a current frame;
a second post-processor configured to generate a second point cloud of a dimension corresponding to the sparse depth map, based on the difference frame; and
a generator configured to generate a dense depth map using the second point cloud and the modeled surface.

2. The image processor of claim 1, wherein the previous frame and the current frame are generated and provided consecutively from a same image sensor.

3. The image processor of claim 1, wherein the first pre-processor generates a specific area, which overlaps a field of view corresponding to the current frame in the sparse depth map, as the first point cloud.

4. The image processor of claim 1, wherein the first post-processor includes:
a clustering component configured to cluster the first point cloud for each subject; and
a modeling component configured to generate the modeled surface by adding virtual points to each point set clustered for each subject.

5. The image processor of claim 4, wherein the clustering component uses a convex hull algorithm or a Delaunay triangulation algorithm.

6. The image processor of claim 1, wherein the second post-processor uses ray casting.

7. The image processor of claim 1, wherein the generator includes:
an estimator configured to estimate dense depth information using the second point cloud and the modeled surface; and
an output component configured to generate the dense depth map based on the dense depth information and the sparse depth map.

8. The image processor of claim 7, wherein the estimator estimates depth values of intersections between the second point cloud and the modeled surface as the dense depth information,
wherein the estimator calculates the depth values using barycentric coordinates.

9. The image processor of claim 7, wherein the output component performs a depth correction operation when generating the dense depth map,
wherein the depth correction operation includes at least one of depth expansion and depth hole filling.

10. An image processing system comprising:
a depth information generator configured to generate a sparse depth map;
an image generator configured to generate a previous frame and a current frame; and
an image processor configured to generate a difference frame corresponding to a difference between the previous frame and the current frame, and generate a dense depth map based on the difference frame and the sparse depth map.

11. The image processing system of claim 10, wherein the image generator consecutively generates the previous frame and the current frame, and provides the image processor with the previous frame and the current frame.

12. The image processing system of claim 10, wherein the image processor includes:
a modeler configured to model a surface of the sparse depth map based on the sparse depth map;
a converter configured to convert the difference frame into a second point cloud having a dimension corresponding to the sparse depth map, based on the previous frame and the current frame; and
a generator configured to generate the dense depth map using the second point cloud and the modeled surface.

13. The image processing system of claim 12, wherein the modeler includes:
a first pre-processor configured to generate a first point cloud based on the sparse depth map; and
a first post-processor configured to generate the modeled surface based on the first point cloud.

14. The image processing system of claim 13, wherein the first pre-processor generates a specific area, which overlaps a field of view corresponding to the current frame in the sparse depth map, as the first point cloud.

15. The image processing system of claim 13, wherein the first post-processor includes:
a clustering component configured to cluster the first point cloud for each subject; and
a modeling component configured to generate the modeled surface by adding virtual points to each point set clustered for each subject.

16. The image processing system of claim 12, wherein the converter includes:
a second pre-processor configured to generate the difference frame based on the previous frame and the current frame; and
a second post-processor configured to generate the second point cloud based on the difference frame.

17. The image processing system of claim 12, wherein the generator includes:
an estimator configured to estimate dense depth information using the second point cloud and the modeled surface; and
an output component configured to generate the dense depth map based on the dense depth information and the sparse depth map.

18. The image processing system of claim 17, wherein the estimator estimates depth values of intersections between the second point cloud and the modeled surface as the dense depth information.

19. The image processing system of claim 17, wherein the output component performs a depth correction operation when generating the dense depth map, and the depth correction operation includes at least one of depth expansion and depth hole filling.

20. A method of operating an image processor, the method comprising:
generating a first point cloud based on a sparse depth map;
modeling a surface of the sparse depth map based on the first point cloud;
generating a difference frame corresponding to a difference between a previous frame and a current frame;
generating a second point cloud of a dimension corresponding to the sparse depth map, based on the difference frame; and
generating a dense depth map using the second point cloud and the modeled surface.
